(19) United States
(12) Patent Application Publication
(10) Pub. No.: US 2026/0343028 A1
(43) Pub. Date: Oct. 29, 2026

(54) SIGNALING FOR IMPLICIT NEURAL REPRESENTATION RECONSTRUCTION

(71) Applicant: InterDigital CE Patent Holdings, SAS, Paris (FR)

(72) Inventors: Francois SCHNITZLER, SAINT AVE (FR); Franck GALPIN, THORIGNE-FOUILLARD (FR); Anne LAMBERT, SAINT-AUBIN-D’AUBIGNE (FR); Pierre HELLIER, THORIGNE-FOUILLARD (FR)

(21) Appl. No.: 19/491,131

(22) PCT Filed: Jun. 10, 2024
(86) PCT No.: PCT/EP2024/065877

§ 371 Date: Dec. 8, 2025

(30) Foreign Application Priority Data
Jun. 13, 2023 (EP) 23305937.7

(51) Int. Cl. H04N 19/70

(52) U.S. Cl. CPC H04N 19/70

(57) ABSTRACT

A method and an apparatus for encoding or decoding one or more syntax elements for using an INR decoder are provided. The one or more syntax elements provides for reconstructing at least one part of an image using at least one Implicit Neural Representation network representative of the at least one part of an image. The one or more syntax elements comprise at least one of an indication relating to the Implicit Neural Representation network, an information providing for constructing an input of the Implicit Neural Representation network, or an information relating to an output of the Implicit Neural Representation network.

This application claims the priority to European Application No. EP23305937.7, filed on 13 Jun. 2023 which is incorporated herein by reference in its entirety.

### TECHNICAL FIELD

The present embodiments generally relate to image, video and/or 3D scene compression using Implicit Neural Representation (INR). The present embodiments relate to a method and an apparatus for encoding, decoding, transmitting metadata used by a decoder for reconstructing a signal encoded using an INR network.

### BACKGROUND

To achieve high compression efficiency, image and video coding schemes usually employ prediction and transform to leverage spatial and temporal redundancy in the video content. Emerging technology makes use of neural networks. Among them, Implicit Neural Representation aims at parameterizing a function which takes coordinates as inputs and outputs values of a signal at these coordinates. INR can be used for instance for compressing image, videos or 3D objects or scene. It can also apply to any type of signal. Approaches are known to construct an INR network for encoding 2D or 3D images. Approaches are also known to compress a neural network. However, any image/video decoder could not reconstruct the image or video for display based only on the INR. Additional information is needed to address any image/video decoder for reconstructing an output signal.

### SUMMARY

According to an aspect, a method for signaling one or more syntax elements for using an INR decoder is provided. The one or more syntax elements provides for reconstructing at least one part of a signal representative of a scene using at least one Implicit Neural Representation network representative of the at least one part of the signal representative of the scene. In some embodiments, the method also comprises encoding the INR network.

According to another aspect, an apparatus for signaling one or more syntax elements for using an INR decoder is provided. The apparatus comprises one or more processors operable to signal the one or more syntax elements that provides for reconstructing at least one part of a signal representative of a scene using at least one Implicit Neural Representation network representative of the at least one part of a signal representative of a scene. In some embodiments, the apparatus is also operable to encode the INR network.

According to another aspect, a method for decoding one or more syntax elements for using an INR decoder is provided. The one or more syntax elements provides for reconstructing at least one part of a signal representative of a scene using at least one Implicit Neural Representation network representative of the at least one part of a signal representative of a scene. In some embodiments, the method also comprises decoding the INR network.

In some embodiments, the method also comprises reconstructing the at least one part of a signal representative of a scene using the one or more syntax elements and the Implicit Neural Representation network.

According to another aspect, an apparatus for decoding one or more syntax elements for using an INR decoder is provided. The apparatus comprises one or more processors operable to decode the one or more syntax elements that provides for reconstructing at least one part of a signal representative of a scene using at least one Implicit Neural Representation network representative of the at least one part of a signal representative of a scene. In some embodiments, the apparatus is also operable to decode the INR network. In some embodiments, the apparatus is also operable to reconstruct the at least one part of a signal representative of a scene using the one or more syntax elements and the Implicit Neural Representation network.

Further embodiments that can be used alone or in combination are described herein.

One or more embodiments also provide a computer program comprising instructions which when executed by one or more processors cause the one or more processors to perform the method for signaling/decoding one or more syntax elements for using an INR decoder according to any of the embodiments described herein. One or more of the present embodiments also provide a non-transitory computer readable medium and/or a computer readable storage medium having stored thereon instructions for signaling/decoding one or more syntax elements for using an INR decoder according to the methods described herein.

One or more embodiments also provide a computer readable storage medium having stored thereon a bitstream generated according to the methods described herein. One or more embodiments also provide a method and apparatus for transmitting or receiving the bitstream generated according to the methods described above.

### BRIEF DESCRIPTION OF THE DRAWINGS

FIG. 1 illustrates an example of a neural network for Implicit Neural Representation.

FIG. 2 illustrates an example of a method for encoding information used by a decoder to reconstruct at least one part of a signal representative of a scene from an encoded INR, according to an embodiment.

FIG. 3 illustrates an example of a method for decoding information used by a decoder to reconstruct at least one part of a signal representative of a scene from an encoded INR, according to an embodiment.

FIG. 4 illustrates an example of a method for reconstructing at least one part of a signal representative of a scene from an encoded INR, according to an embodiment.

FIG. 5 illustrates an example of a method for generating coordinates to be used by a decoder to reconstruct at least one part of a signal representative of a scene from an encoded INR, according to an embodiment.

FIG. 6 illustrates an example of a method for performing an inference of the INR network, according to an embodiment.

FIG. 7 illustrates an example of a method for reconstructing the at least one part of a signal representative of a scene from an output of the INR network, according to an embodiment.

FIG. 8 illustrates a block diagram of a system within which aspects of the present embodiments may be implemented.

FIG. 9 illustrates a block diagram of a system within which aspects of the present embodiments may be implemented, according to another embodiment.

FIG. 10 shows two remote devices communicating over a communication network in accordance with an example of the present principles.

FIG. 11 shows the syntax of a signal in accordance with an example of the present principles.

### DETAILED DESCRIPTION

This application describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

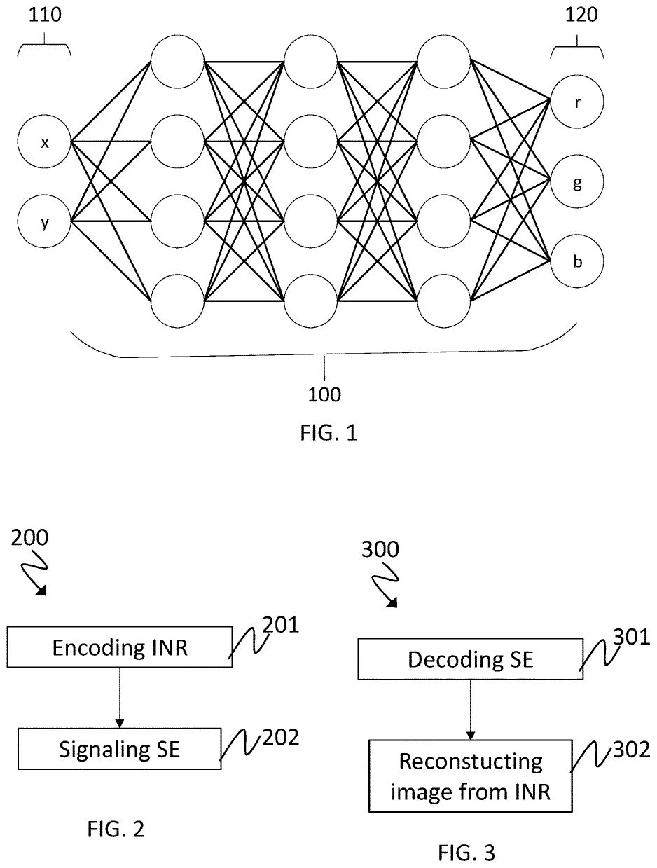

The aspects described and contemplated in this application can be implemented in many different forms. FIGS. 1-11 below provide some embodiments, but other embodiments are contemplated and the discussion of FIGS. 1-11 does not limit the breadth of the implementations.

In the present application, the terms “reconstructed” and “decoded” may be used interchangeably, the terms “pixel” and “sample” may be used interchangeably, the terms “image,” “picture” and “frame” may be used interchangeably.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

Unless indicated otherwise, or technically precluded, the aspects described in this application can be used individually or in combination.

At least one of the aspects generally relates to image, video or 3D data encoding and decoding using Implicit Neural Representation. More generally, at least one of the aspects described herein relates to using an Implicit Neural Representation for encoding/decoding any signal representative of a scene.

At least one other aspect generally relates to transmitting a bitstream generated or encoded. These and other aspects can be implemented as a method, an apparatus, a computer readable storage medium having stored thereon instructions for encoding or decoding data signal representative of a scene according to any of the methods described, and/or a computer readable storage medium having stored thereon a bitstream generated according to any of the methods described.

While not standardized yet, MPEG group standardization is exploring new Neural Compression technologies. In an AhG within WG4, INR (INR stands for Implicit Neural Representation) based compression techniques are investigated by research groups in academia and in a few companies and the number of papers is growing exponentially.

Studies on INR focuses for 2D and video compression, but INR is investigated for many other signals, in particular 3D scenes or objects. Furthermore, these approaches have a far lower computational complexity than end-to-end neural compression approaches.

FIG. 1 illustrates an example of a neural network used for Implicit Neural Representation (INR). Such a neural network used for INR can be referred to as an INR network. INR parameterizes a signal as a function 100, which takes coordinates 110 as input and outputs values 120 of a signal at these coordinates. INR has recently been applied to image, videos or 3D objects among other applications. In the image case, the inputs 110 can be pixel coordinates (x, y) and the INR may output 120 the color values (r, g, b) or (y, u, v) of the input pixel. The input coordinates may be modified by a transformation before being used as input for the neural network. This transformation can be a Fourier mapping, coordinate transformation, normalization etc. The INR can be used to reconstruct a signal by computing the signal values for every necessary coordinate inputs. It can be used to upsample a signal by generating output for input coordinates corresponding to the upsampled pixels, for example the mean of the coordinates between two consecutive pixels for upsampling by a factor of 2.

Other kind of inputs can be considered for instance when representing the scene as a volume, using point clouds, meshes, or any other suitable representation of a scene. In some variants, the scene can also be animated/dynamic, in other words varying in time.

An INR network 100 is typically a neural network, composed of multiple neural layers, such as fully connected layers. In FIG. 1, the network has four layers. Intermediate outputs are represented by circles. Each neural layer can be described as a function that first multiplies the input by a tensor, adds a vector called the bias and then applies a nonlinear function on the resulting values. The shape (and other characteristics) of the tensor and the type of non-linear functions are called the architecture of the network. The values of the tensor and the bias are denoted herein by the term “weights”. The weights and, if applicable, the parameters of the non-linear functions, are called the parameters θ of the network. The architecture and the parameters define a “model”. The notation f_{θ} is used to denote an INR function parameterized by θ.

A typical process to encode a signal using an INR is as follows. First the weights θ (or a subset of them) of the INR network are optimized to reconstruct the signal. Next, these weights are optionally encoded to create the output bitstream. For an image I of size (M×N), the weights θ can for example be optimized by minimizing the following loss function:

$$Loss = D ( I , {f}_{θ} ) + λ R ( θ )$$

$${D}_{M S E} = \frac{1}{M N} {\sum }_{x , y} {( I ( x , y ) - {f}_{θ} ( x , y ) )}^{2} ,$$

where D is a distortion which quantifies the difference between the reconstructed image by f_{θ} to the original image I, R is the bitrate of the encoded parameters and λ a trade-off parameter between D and R. D could be any differentiable distortion measure, such as mean squared error as in the second equation. M and N are the width and height of an image. Other metrics such as LPIPS (learned perceptual image patch similarity) can also be used in this case. The optimization of the weights θ is typically performed by a machine learning approach such as a batch gradient descent method.

To decompress the signal, f_{θ} is evaluated at all relevant coordinates. These coordinates can be selected at decoding. A typical choice would be all pixel coordinates for an image or video. As an example, for a 256×256 pixel image, these coordinates could be all pairs (x, y) for all xϵ{0, 1, . . . , 255} and yϵ{0, 1, . . . , 255}. Other choices are possible, for example to upsample, downsample or extend the original image.

The scientific literature describes many approaches to construct an INR network to encode a 2D or 3D image. There are also many existing approaches to compress and encode a neural network, such as MPEG Neural Network Compression (NNC) standard.

However, an INR network alone, optimized by an encoder, and potentially encoded by NNC, is not sufficient to reconstruct an image at a decoder. In operation, that decoder needs additional information in order to properly reconstruct the encoded input signal.

Some embodiments provide for encoding information necessary for a decoder to reconstruct the input signal (image or video, or 3D data for example). In some variants, a bitstream is described that contains both an INR network and additional information necessary for signal reconstruction, including an SEI syntax. It is also described how a decoder can use this information to reconstruct a signal.

Some embodiments describe the mandatory information that the bitstream needs to carry, whatever the INR method used.

FIG. 2 illustrates an example of a method 200 for encoding information used by a decoder to reconstruct at least one part of a signal representative of a scene from an encoded INR, according to an embodiment. A bitstream is constructed that contains an INR network, optimized and encoded by off-the-shelves approaches and an encoding of information necessary for a decoder to use the INR network to reconstruct the signal. At 201, the INR is encoded using for instance a NNC encoder. The INR is representative of at least one part of a signal representative of a scene. This can be a region of an image, a component of the image, a part of a video, or data of a 3D scene static or dynamic. The determination of the weights of the INR is done using off-the-shelves approaches. The weights of the INR are encoded in the bitstream.

At 202, one or more syntax elements (SE) are also signaled in the bitstream. These one or more syntax elements provides for reconstructing at a decoder the at least one part of a signal representative of a scene using the encoded INR.

FIG. 3 illustrates an example of a method 300 for decoding information used by a decoder to reconstruct at least one part of a signal representative of a scene from an encoded INR, according to an embodiment. For instance, the bitstream encoded by the method described in relation with FIG. 2 is decoded. At 301, one or more syntax elements (SE) are decoded from the bitstream. At 302, the syntax elements are provided to a decoder for reconstructing the at least one part of a signal representative of a scene using the syntax elements and the Implicit Neural Representation network.

Some embodiments are provided below that describe examples of syntax elements mentioned above. Also, some embodiments are provided below for reconstructing the at least one part of a signal representative of a scene using the decoded syntax elements.

As discussed above, the bitstream should contain signaling for some or all the following elements.

In a variant, a type of the INR used for representing the at least one part of a signal representative of a scene is signaled. This signaling is related to the INR used, for example a single network for a whole image or scene, one network per channel or per groups of channels (such as one network for Y and one for UV), one network per patch in an image or per sub-volume of a scene etc.

In another variant, information relating to the input of the INR network is signaled. These elements describe information necessary to construct the input of the INR.

The dimensions of the domain can be signaled, for example an image is a 2D signal. This describes the dimensions of the output image or scene.

Input coordinate normalization can be signaled. Coordinates normalization refers to the range of the coordinates expected by the INR. For example, one INR may expect input values in the range [0,1]², in the range (1, . . . , width)×(1, . . . , height) or in a range [−1,1]².

Input coordinate transformation(s) can be signaled. Input coordinates are often transformed by a function before being fed to the neural network. In order to reconstruct an image, it is necessary to signal the transformation(s) that must be used. If multiple transformations are present, their order may also be signaled.

Maximum upsampling size may be signaled. This information can be optional. It may be interesting to signal the maximum recommended upsampling possible with this INR. The maximum upsampling could be defined in various ways, for example by the largest upsampling rate that does not increase distortion by a set amount or the upsampling rate where INR upsampling is better than an upsampling algorithm available in the decoder.

In another variant, information relating to models are signaled. In practice, the models are usually integerized. That is the weights are quantized and expressed as fixed point values, and the floating point operations are transformed into their integer counterpart. For example, activation layers (such as sin (x)) might be transformed as a LUT when the network is integerized. For this reason, the range and bitdepth of the inputs/outputs need to be precisely described.

In another variant, information relating to the signal reconstruction are signaled. For example, the output format can be signaled. This signaling indicates the format of an image encoding generated by the INR network, for example RGB or YUV. Additional signaling may be necessary depending on the encoding. As an example, when the YUV format is used, signaling for the chroma subsampling and/or the phase might be necessary.

The output range of the INR network can be signaled, for example [0,255] or [0,1].

Assuming a quantized network, an example of syntax that signals one or more of the information discussed above is illustrated in Table 1 below: table 1 describes some of the syntax elements that might be needed to describe the input and output of the network.

TABLE 1

| | Descriptor |
|---|---|
| inr_model( payloadSize ) { | |
| inr_model_type | u(8) |
| inr_inference_type | u(1) |
| inr_input_dimension_count_minus1 | u(3) |
| for(i=0;i< inr_input_dimension_count_minus1+1;i++) { | |
| inr_input_range_minus1[i] | u(16) |
| inr_input_quantizer[i] | u(16) |
| inr_input_zero_centered[i] | u(1) |
| } | |
| inr_input_transformation_count | u(3) |
| for(i=0;i< inr_input_transformation_count;i++) { | |
| inr_input_transformation_type [i] | u(8) |
| if (inr_input_transformation_type [i]== 2 ) { | |
| inr_Fourier_mapping_coefficient_count_minus1[i] | u(3) |
| for(j=0;j<inr_Fourier_mapping_coefficient_count_minus1[i]+1;j++) { | |
| inr_Fourier_mapping_coefficient[i][j] | u(16) |
| } | |
| } | |
| } | |
| inr_output_type | u(3) |
| if (inr_output_type == 0 ) { | |
| inr_output_dimension_count_minus1 | u(3) |
| for(i=0;i< inr_output_dimension_count_minus1+1;i++) { | |
| inr_output_ range_minus1[i] | u(16) |
| inr_output_quantizer[i] | u(16) |
| inr_output_zero_centered[i] | u(1) |
| } | |
| } | |
| } | |

The semantics of the syntax elements shown in Table 1 are as follows:
inr_model_type: tag describing the type of INR approach used to generate the output of the INR. For example, the following types may be defined:
   inr_model_type=0: the model takes as input a vector of dimension d (specified by—inr_input_dimension_count_minus1) and output an output. Input is sampled uniformly in the range specified for each dimension.
   inr_model_type=1: Input is sampled using an 32-times downsampling function in the range specified for each dimension, at the center of each 32×32 patch. Alternatively, an additional parameter may specify the downsampling range.
   inr_model_type=2: the INR contains two neural networks, the first one is applied before the coordinate transforms and the second one is applied afterwards.
   Xxxx: other approaches could also be specified.
inr_inference_type: tag describing the type of computation: integer or floating point. This may impact the syntax of some elements. As an example, a value of 0 means integer and 1 floating point computation.
inr_input_dimension_count_minus1: integer describing the number of dimensions minus 1 of the input. For example, for an image INR model, the input has 2 dimensions (width and height), thus inr_input_dimension_count_minus1 is 1.
inr_input_range_minus1[i]: for each dimension in the input, the range of the input minus 1. The number of valid values will be inr_input_range [i]=inr_input_range_minus1[i]+1.
inr_input_quantizer[i]: for each dimension in the input, integer representing the quantizer of the fixed point integer. For example, if inr_input_quantizer[i]=0, the input x on dimension d represents the value x. If inr_input_quantizer[i]=3, the input x on dimension d represents the value (x/2\hat{ }3).
inr_input_zero_centered[i]: if the flag is 0 (false), the input on dimension d is in the range [0, inr_input_range[i]], if the flag is 1 (true), the value are in the range [inr_input_range[i]/2−inr_input_range [i], inr_input_range[i]/2]. Alternatively, the flag inr_input_zero_centered can be replaced by an explicit encoding of the offset of the zero value.

For example, a model aimed at encoding an image of size W×H, with a sub-pixel accuracy of 1/8 of pixel (i.e. the original image can be upsampled 8 times by the network) is described by the following parameters:
inr_inference_type=0
inr_input_dimension_count_minus1=1
inr_input_range_minus1[0]=W−2
inr_input_quantizer [0]=3
inr_input_zero_centered[0]=0
inr_input_range_minus1 [1]=H−2
inr_input_quantizer [1]=3
inr_input_zero_centered[1]=0

The generator of coordinates for the input, to recover the image in its original size, would then be:

```
for(x=0;x<=inr_input_range[0];x++) {
  for(y=0;y<=inr_input_range[1];y++) {
    output(x,y)=infer(x* 2\hat{ }(inr_input_quantizer[0]),y*2\hat{ }((inr_input_quantizer[1])
  }
}
```

Where infer (x,y) applies a model inference using the input coordinates (x,y).

Another example where the model generates a 3D volume of points for input coordinates in the range [−1,1], for a voxel coordinates accuracy of 1/256:
inr_inference_type=0
inr_input_dimension_count_minus1=2
inr_input_range_minus1[0]=1
inr_input_quantizer [0]=8
inr_input_zero_centered[0]=1
inr_input_range_minus1[1]=1
inr_input_quantizer [1]=8
inr_input_zero_centered[1]=1
inr_input_range_minus1[2]=1
inr_input_quantizer [2]=8
inr_input_zero_centered[2]=1

The generator of coordinates for the input, to recover the volume would then be:

```
fx=2\hat{ }(inr_input_quantizer[0]
fy=2\hat{ }(inr_input_quantizer[1]
fz=2\hat{ }(inr_input_quantizer[2]
startx=(inr_input_range[0]/2-inr_input_range[0])*fx=-256
endx=(inr_input_range[0]/2)*fx=256
starty=(inr_input_range[1]/2-inr_input_range[1])*fy=-256
endy=(inr_input_range[1]/2)*fy=256
startz=(inr_input_range[2]/2-inr_input_range[2])*fz=-256
endz=(inr_input_range[2]/2)*fz=256
for(x=startx;x<=endx;x++) {
  for(y=starty;y<endy;y++) {
    for(z=startz;z<endz;z++) {
      output(x-startx,y-starty,z-startz)=infer(x,y,z)
    }
  }
}
```

inr_input_transformation_count: integer describing the number of successive transformations applied to the input prior to being fed to the INR network. For example, if one transformation is applied, the value is 0. If three transformations are applied, the value is 2.
inr_input_transformation_type[i]: tag describing the type of transformations applied to the input. The type 0 is let to define custom type. For example, the following types may be defined:
   inr_input_transformation_type[i]=1: hyperspherical coordinates transform
   inr_input_transformation_type[i]=2: Fourier mapping using a custom Fourier mapping matrix. This type value necessitates that inr_inference_type is float. In that case, the custom matrix is described as follows:
      inr_Fourier_mapping_coefficient_count_minus1[i]: integer describing the number of Fourier mapping coefficient transformations minus 1.
      inr_Fourier_mapping_coefficient[i][j]: value of a Fourier mapping coefficient.
   inr_input_transformation_type[i]=3: Normalization
   inr_input_transformation_type[i]=4: Fourier mapping using a first predefined Fourier mapping matrix
   inr_input_transformation_type[i]=5: Fourier mapping using a second predefined Fourier mapping matrix
   inr_input_transformation_type[i]=6: Fourier mapping using a predefined Fourier mapping LUT
   Etc
inr_output_type: described the type of output. The type 0 is let to define custom type. Other types can for example be predefined as:
   inr_output_type=1: RGB output with each component encoded on 8 bits in the range [0,255],
   inr_output_type=2: RGB output with each component encoded on 10 bits in the range [0,1023],
   inr_output_type=3: YUV output with each component encoded on 8 bits in the range [0,255],
   inr_output_type=4: YUV output with each component encoded on 10 bits in the range [0,1023],
   inr_output_type=5: RGBA output with each component encoded on 8 bits in the range [0,255], where A represents an alpha value, etc.
when the type is 0, the output characteristics is described using the same logic as for the input (number of components, range, quantizer, offset of the zero value).

For example, a model without any transformation and output RGB outputs in the range [0,255] is described by the following parameters:
inr_input_transformation_count=0
inr_output_type=1

A floating point INR where coordinates must be mapped using a custom Fourier mapping with 3 coefficients a, b and c and then normalized and where the output is in the YUV format is described as follows:
inr_input_transformation_count=2
Inr_input_transformation_type[0]=2
inr_Fourier_mapping_coefficient_count_minus1[0]=2
inr_Fourier_mapping_coefficient[0][0]=a
inr_Fourier_mapping_coefficient[0][1]=b
inr_Fourier_mapping_coefficient[0][2]=c
Inr_input_transformation_type[1]=3
inr_output_type=3

Note that a transformation might be expressed as a LUT, typically for integer inference. For example, and building on the previous example (reconstructing a set of 3D points), with a Fourier mapping, one signal decoding might be computed as follows:

```
fx=2\hat{ }(inr_input_quantizer[0]
fy=2\hat{ }(inr_input_quantizer[1]
fz=2\hat{ }(inr_input_quantizer[2]
startx=(inr_input_range[0]/2-inr_input_range[0])*fx=-256
endx=(inr_input_range[0]/2)*fx=256
starty=(inr_input_range[1]/2-inr_input_range[1])*fy=-256
endy=(inr_input_range[1]/2)*fy=256
startz=(inr_input_range[2]/2-inr_input_range[2])*fz=-256
endz=(inr_input_range[2]/2)*fz=256
for(x=startx;x<=endx;x++) {
  for(y=starty;y<endy;y++) {
    for(z=startz;z<endz;z++) {
      mapped_coord = LUT_transform(x,y,z)
      output(x-startx,y-starty,z-startz)=infer(mapped_coord)
    }
  }
}
```

The LUT_transform function returns the mapped coordinates in the “mapped_coord” variable. One approach to construct the LUT_transform for a Fourier mapping can be as follows. Assuming a set of Fourier mapping coefficients Fourier_mapping_coef and an input range [start, end]:

```
LUT_table_s = initialize( )
LUT_table_c = initialize( )
for(x=start;x<=end;x++){
  range = get_range(x)
  for(i=0;i<len(Fourier_mapping_coef);i++)
  LUT_table_s[x][i]=sin_int_rep(range,Fourier_mapping_coef[i])
  LUT_table_c[x][i]=cos_int_rep(range,Fourier_mapping_coef[i])
}
```

where len(Fourier_mapping_coef) returns the length of the input set Fourier_mapping_coef, get_range(x) returns the range of real values mapped to the integer representation x, for example, if the uniform quantization step is δ and x′=inv_quantization(x) is the real value mapped to x, typically

$$get\_range ( x ) = ( {x}^{′} - \frac{δ}{2} , {x}^{′} + \frac{δ}{2} ) .$$

sin_int_rep(range,coef) is a function that returns an integer representation corresponding to the value of the sinus function on this interval. For example, the following could be used:

$$sin\_int \_rep ( range , coeff ) = quantize ( sin ( coef * \frac{( range [ 0 ] + range [ 1 ] )}{2} ) )$$

$$sin\_int \_rep ( range , coef ) = quantize ( \frac{{\int }_{r a n g e [ 0 ]}^{r ange [ 1 ]} sin ( coef * t ) dt}{range [ 1 ] - range [ 0 ]} )$$

cos_int_rep(range,coef) may be defined similarly:

$$cos\_int \_rep ( range , coeff ) = quantize ( cos ( coef * \frac{( range [ 0 ] + range [ 1 ] )}{2} ) )$$

$$cos\_int \_rep ( range , coef ) = quantize ( \frac{{\int }_{r a n g e [ 0 ]}^{r ange [ 1 ]} cos ( coef * t ) dt}{range [ 1 ] - range [ 0 ]} )$$

It is also possible to add other multipliers within the sin or cos such as it or a multiple of it. It is also possible to use the fact that cos (x)=sin (π−x) to avoid storing a table for cosine value and instead store a LUT_complementary_angle table storing integer representation of π−x. In that case, it is for example possible to use

LUT_table_c[x][i]: =LUT_table_s [LUT_complementary_angle table [x]][i].

Then, LUT_transform (x,y,z) may be implemented as follows:

LUT_transform (x,y,z) {

```
  offset=0
  n_coef = len(Fourier_mapping_coef)
  input = (x,y,z)
  for(j=0;j<len(input);j++):
    val = input[i]
    for(i=0;i<n_coef;i++)
      output[offset+i]= LUT_table_s[val][i]
      output[offset+i+n_coef]= LUT_table_c[val][i]
  offset+=2*n_coef
}
```

In some embodiments, the syntax elements mentioned with FIGS. 2 and 3 can also comprise network configuration information. For example, Neural network encoding can be signaled. This element signals how the INR neural network is encoded in the bitstream. It may for example be a value associated to a specific format such as NNC or Open Neural Network Exchange format and/or a particular version of a format.

Inference engine configuration can be signaled. It may be interesting to add signaling related to the configuration of the inference engine, which could for example include the precision to use for the operations, the memory necessary to store the INR network or the inference engine to use.

Table 2 below describes some of the syntax elements that might be needed to describe the network configuration:

TABLE 2

| | Descriptor |
|---|---|
| inr_network( payloadSize ) { | |
| inr_mode_idc | ue(v) |
| if( inr_mode_idc = = 1 ) { | |
| inr_tag_uri | u(8) |
| inr_uri | st(v) |
| } | |
| inr_complexity_info_present_flag | ue(v) |
| if( inr_complexity_info_present_flag ) { | |
| inr_parameter_type_idc | u(2) |
| if( inr_parameter_type_idc != 2 ) | |
| inr_log2_parameter_bit_length_minus3 | u(2) |
| inr_num_parameters_idc | u(6) |
| inr_num_mac_operations_idc | ue(v) |
| inr_total_kilobyte_size | ue(v) |
| } | |
| if( inr_mode_idc = = 0 ) { | |
| /* ISO/IEC 15938-17 bitstream */ | |
| while( !byte_aligned( ) ) | |
| inr_reserved_zero_bit_b | u(1) |
| for( i = 0; more_data_in_payload( ); i++ ) | |
| inr_payload_byte[i] | b(8) |
| } | |
| } | |

Semantics for table 2 are as follows:

inr_mode_idc indicates the format used to encode the Neural network. For example, a value equals to 0 indicates that this SEI message contains an ISO/IEC 15938-17 bitstream, a value of 1 indicates that this SEI message contains a neural network encoded by a format identified by the tag URI inr_tag_uri.

inr_tag_uri contains a tag URI with syntax and semantics as specified in IETF RFC 4151 identifying the format and associated information about the INR network or an update encoded here.

inr_uri contains a URI with syntax and semantics as specified in IETF Internet Standard 66 identifying the neural network used as an INR network or an update relative to the network.

inr_complexity_info_present_flag specifies whether syntax element indicating the complexity of the INR network are present or not. For example, a value equal to 1 specifies that one or more syntax elements that indicate the complexity of the INR network are present, inr_complexity_info_present_flag equal to 0 specifies that no syntax element indicating the complexity of the INR network is present.

inr_parameter_type_idc equal to 0 indicates that the neural network uses only integer parameters. inr_parameter_type_flag equal to 1 indicates that the neural network may use floating point or integer parameters. inr_parameter_type_idc equal to 2 indicates that the neural network uses only binary parameters. inr_parameter_type_idc equal to 3 is reserved for future use.

inr_log2_parameter_bit_length_minus3 equal to 0, 1, 2, and 3 indicates that the neural network does not use parameters of bit length greater than 8, 16, 32, and 64, respectively. When inr_parameter_type_idc is present and inr_log 2_parameter_bit_length_minus3 is not present the neural network does not use parameters of bit length greater than 1.

inr_num_parameters_idc indicates the maximum number of neural network parameters for the INR network in units of a power of 2 (or another power of 2). inr_num_parameters_idc equal to 0 indicates that the maximum number of neural network parameters is unknown. The value inr_num_parameters_idc shall be in the range of 0 to 63, inclusive.

If the value of inr_num_parameters_idc is greater than zero, the variable maxNumParameters is derived as follows:

maxNumParameters=(2<<inr_num_parameters_idc)−1

The number of neural network parameters of the post-processing filter shall be less than or equal to maxNumParameters.

inr_num_mac_operations_idc greater than 0 indicates that the maximum number of multiply-accumulate operations per inference of INR network is less than or equal to inr_num_mac_operations_idc. inr_num_mac_operations_idc equal to 0 indicates that the maximum number of multiply-accumulate operations of the network is unknown. The value of inr_num_mac_operations_idc shall be in the range of 0 to 2³²-1, inclusive.

inr_total_kilobyte_size greater than 0 indicates a total size in kilobytes required to store the uncompressed parameters for the neural network. The total size in bits is a number equal to or greater than the sum of bits used to store each parameter. inr_total_kilobyte_size is the total size in bits divided by 8000, rounded up. inr_total_kilobyte_size equal to 0 indicates that the total size required to store the parameters for the neural network is unknown. The value of inr_total_kilobyte_size shall be in the range of 0 to 2³²-1, inclusive.

inr_reserved_zero_bit_b shall be equal to 0 in bitstreams conforming to the syntax provided herein. Decoders shall ignore INR SEI messages in which inr_reserved_zero_bit_b is not equal to 0.

inr_payload_byte [i] contains the i-th byte of a bitstream conforming to ISO/IEC 15938-17.

The byte sequence inr_payload_byte [i] for all present values of i shall be a complete bitstream that conforms to ISO/IEC 15938-17.

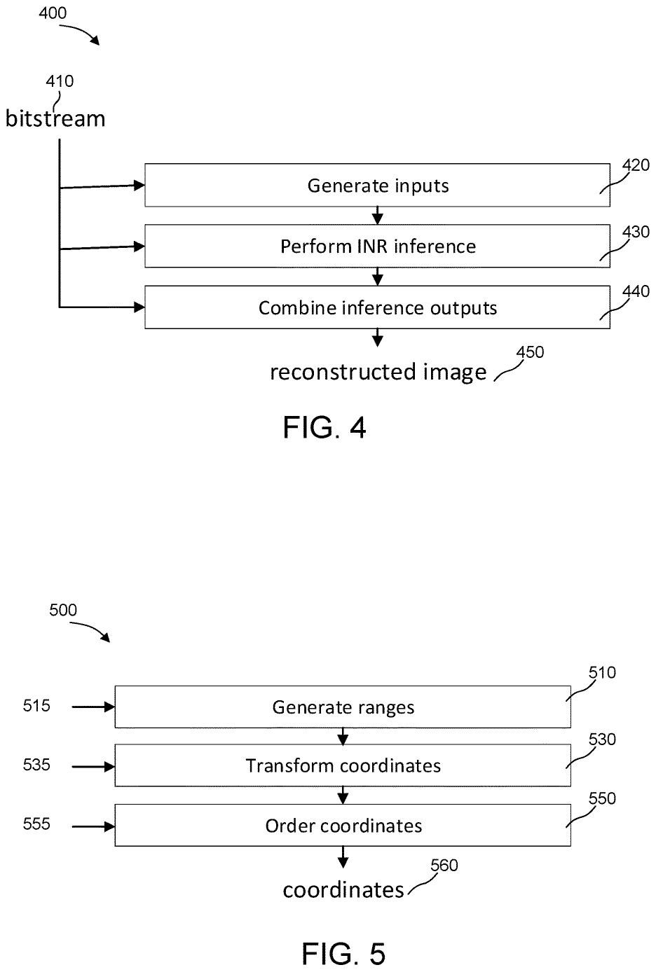

The syntax elements provided above are only examples, other syntax elements can be added or some can be removed. Also, the order in which the syntax elements are presented is for illustrative purposes, one or more of the syntax elements can be presented in any other order. FIG. 4 illustrates a high level overview of an example method 400 that a decoder may rely on to decode a bitstream 410 that comprises an encoded INR representative of at least one part of a signal representative of a scene. Embodiments are described here for a signal representative of an image. But the described embodiments apply to any other kinds of signal representative of a scene. The bitstream also comprises one or more syntax elements according to an embodiment as described above in relation with Table 1 or 2 for example. The input bitstream 410 or parts of this bitstream is/are fed to the modules of the process. The module 420 extracts information from the bitstream, generates and outputs the set of input coordinates for the INR networks. The module 430 performs the INR inference. It is responsible for decoding the INR network and for generating the output of the INR network or in other words to associate the output of the INR network to each set of input coordinates. The module 440 combines these outputs to reconstruct the image. This may involve transformations on these outputs to match the requested output format. But this module is also responsible to properly arrange these values into an image format.

FIG. 5 illustrates one possible embodiment of the input generation module 520. In a step 510, the size of the original image signaled in the bitstream is taken as input 515 and used to generate input coordinates corresponding to the original image. For example, these input coordinates are typically pairs (x, y) positions where x and y respectively range from one to the width or height of the image. Alternatives are possible depending on the type of INR used, for example using coordinates associated to blocks of pixels. For example, for an INR that outputs color values of a block of pixel, the input is typically the coordinates of the block. Such an INR is for instance defined with inr_model_type=1, using the syntax provided below, with this model type the input coordinates are subsampled accordingly.

Step 530 takes as input the signals in the bitstream related to the coordinate transformation(s) 535 and applies these transformations to the coordinates provided at 510.

Step 550 arranges the coordinates based on the type of INR 555 signaled in the bitstream. This step may also be optional. This step ensures that the proper values will be used to each input of the INR network. This module outputs the coordinates 560 that will be used by the INR network.

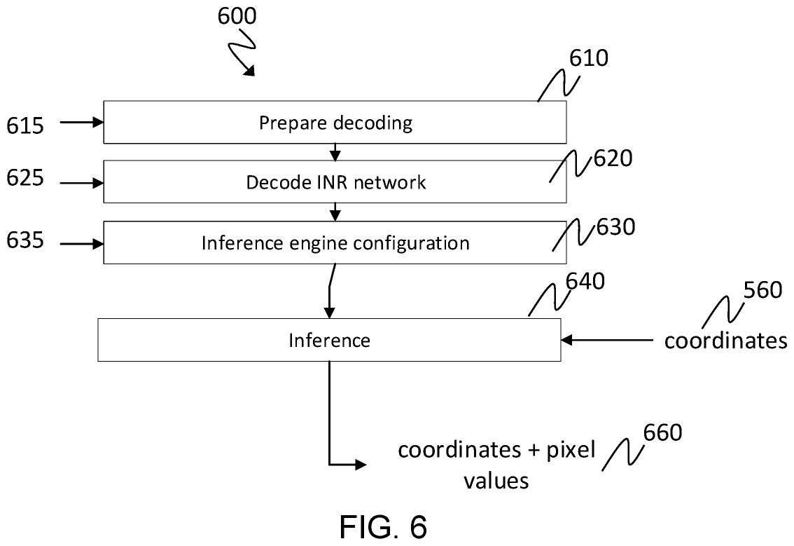

FIG. 6 illustrates one possible embodiment of the INR inference module 430. In a step 610, the INR network encoding signaled in the bitstream 615 is used as input to prepare the decoding. This piece of information is used to configure the INR decoder module 620. This module 620 takes as input the bitstream of the INR network 625 (that is the encoded INR) and outputs the decoded INR network.

The module 630 uses the inference engine configuration 635 and the decoded INR network to initialize the inference engine 640. This module 630 may involve steps such as reserving computational resources, loading the decoded model into the memory of the processor that will perform inference, transforming the network into the format expected by the inference engine, adapting the weights of the network for the inference engine etc. It may also involve defining which coordinates are used in which networks if multiple networks are used in the INR. In that case, the input 635 of the module 630 may also include the signals for the type of INR used.

This initialized inference engine 640 takes as input the coordinates 560. These coordinates are fed to the INR network and inference is performed to compute values associated to these pixels. Several variations are possible for the inference. For example, inference can be performed on one set of coordinates at a time, on multiple sets of coordinates at the same time or on multiple processors in parallel. This module outputs the coordinates and the associated pixel values 660 that have been computed.

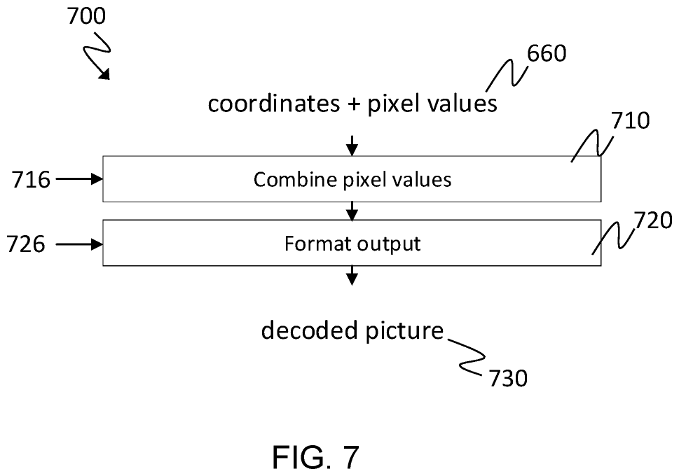

FIG. 7 illustrates one possible embodiment of the inference output combination module 440. A module 710 receives the coordinates and associated pixels values 660. It may also use as input (716) the type of INR used and the output format of the networks. This module is responsible for reordering the pixel values in a traditional image format, for example in a row-major or column-major ordered matrix. If necessary, this module may also take as input the type of INR used. One example is when the input coordinates are associated to the values of a block of pixels, in order to know the order of the output or when this step involves the combination of the output of several INR networks. Another example is when different networks generate Y and UV values respectively.

A module 720 takes as input the range of the outputs of the network 726. It then performs a coordinate change on the pixel values to obtain values lying in a traditional range for images, for examples [0,255] or [0,1]. The final output 730 is the decoded picture.

This output may be further modified to obtain a different image format, for example from YUV to RGB or the opposite.

The process described above is only one example. Additional steps might be necessary, or some steps might be omitted depending on the INR type considered or signaled in the bitstream.

The ordering of some steps may also be different. For example, upsampling could be performed separately, outside input range generation 420. Even though, a sequential process has been described, some operations could be performed in parallel. For example, the network could be decoded 620 at the same time as the coordinates are prepared 420. Some steps may also be moved to different modules.

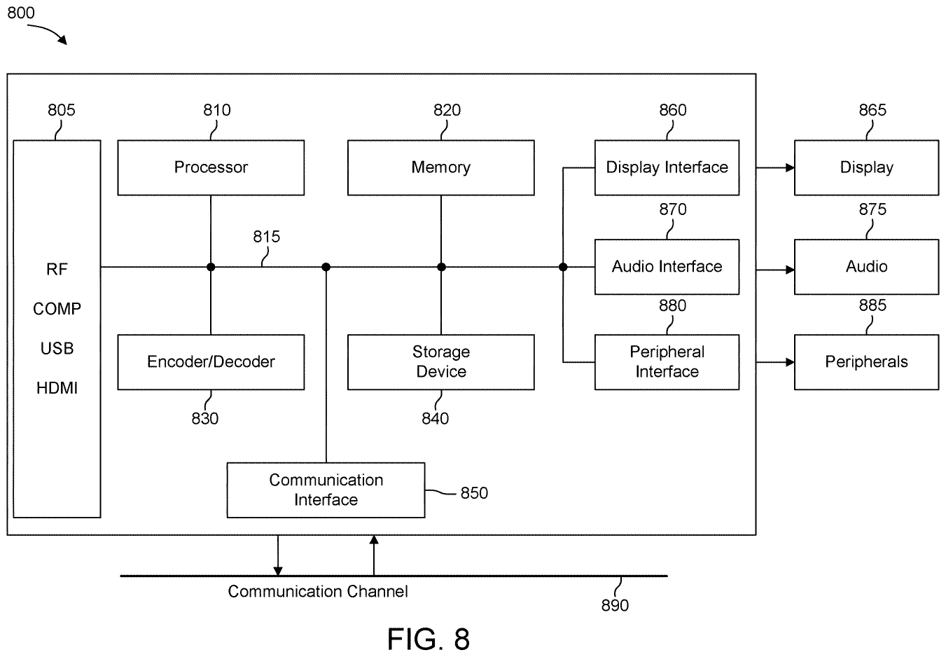

FIG. 8 illustrates a block diagram of an example of a system in which various aspects and embodiments can be implemented. System 800 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 800, singly or in combination, may be embodied in a single integrated circuit, multiple ICs, and/or discrete components. For example, in at least one embodiment, the processing and encoder/decoder elements of system 800 are distributed across multiple ICs and/or discrete components. In various embodiments, the system 800 is communicatively coupled to other systems, or to other electronic devices, via, for example, a communications bus or through dedicated input and/or output ports. In various embodiments, the system 800 is configured to implement one or more of the aspects described in this application.

The system 800 includes at least one processor 810 configured to execute instructions loaded therein for implementing, for example, the various aspects described in this application. Processor 810 may include embedded memory, input output interface, and various other circuitries as known in the art. The system 800 includes at least one memory 820 (e.g., a volatile memory device, and/or a non-volatile memory device). System 800 includes a storage device 840, which may include non-volatile memory and/or volatile memory, including, but not limited to, EEPROM, ROM, PROM, RAM, DRAM, SRAM, flash, magnetic disk drive, and/or optical disk drive. The storage device 840 may include an internal storage device, an attached storage device, and/or a network accessible storage device, as non-limiting examples.

System 800 includes an encoder/decoder module 830 configured, for example, to process data to provide an INR representative of at least one part of a signal representative of a scene and/or an encoded INR representative of at least one part of a signal representative of a scene or a decoded INR representative of at least one part of a signal representative of a scene and/or at least one part of the signal reconstructed from the decoded INR, and the encoder/decoder module 830 may include its own processor and memory. The encoder/decoder module 830 represents module(s) that may be included in a device to perform the encoding and/or decoding functions. As is known, a device may include one or both of the encoding and decoding modules. Additionally, encoder/decoder module 830 may be implemented as a separate element of system 800 or may be incorporated within processor 810 as a combination of hardware and software as known to those skilled in the art.

Program code to be loaded onto processor 810 or encoder/decoder 830 to perform the various aspects described in this application may be stored in storage device 840 and subsequently loaded onto memory 820 for execution by processor 810. In accordance with various embodiments, one or more of processor 810, memory 820, storage device 840, and encoder/decoder module 830 may store one or more of various items during the performance of the processes described in this application. Such stored items may include, but are not limited to, the input image, video, 3D data, weights of the INR, the decoded image, decoded video, decoded 3D data or portions of the decoded data, the bitstream, matrices, variables, and intermediate or final results from the processing of equations, formulas, operations, and operational logic.

In some embodiments, memory inside of the processor 810 and/or the encoder/decoder module 830 is used to store instructions and to provide working memory for processing that is needed during encoding or decoding. In other embodiments, however, a memory external to the processing device (for example, the processing device may be either the processor 810 or the encoder/decoder module 830) is used for one or more of these functions. The external memory may be the memory 820 and/or the storage device 840, for example, a dynamic volatile memory and/or a non-volatile flash memory. In several embodiments, an external non-volatile flash memory is used to store the operating system of a television

The input to the elements of system 800 may be provided through various input devices as indicated in block 805. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 8, include composite video.

In various embodiments, the input devices of block 805 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which can be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 800 to other electronic devices across USB and/or HDMI connections. It is to be understood that various aspects of input processing, for example, Reed-Solomon error correction, may be implemented, for example, within a separate input processing IC or within processor 810 as necessary. Similarly, aspects of USB or HDMI interface processing may be implemented within separate interface ICs or within processor 810 as necessary. The demodulated, error corrected, and demultiplexed stream is provided to various processing elements, including, for example, processor 810, and encoder/decoder 830 operating in combination with the memory and storage elements to process the data stream as necessary for presentation on an output device.

Various elements of system 800 may be provided within an integrated housing, Within the integrated housing, the various elements may be interconnected and transmit data therebetween using suitable connection arrangement 815, for example, an internal bus as known in the art, including the 12C bus, wiring, and printed circuit boards.

The system 800 includes communication interface 850 that enables communication with other devices via communication channel 890. The communication interface 850 may include, but is not limited to, a transceiver configured to transmit and to receive data over communication channel 890. The communication interface 850 may include, but is not limited to, a modem or network card and the communication channel 890 may be implemented, for example, within a wired and/or a wireless medium.

Data is streamed to the system 800, in various embodiments, using a Wi-Fi network such as IEEE 802.11 (IEEE refers to the Institute of Electrical and Electronics Engineers). The Wi-Fi signal of these embodiments is received over the communications channel 890 and the communications interface 850 which are adapted for Wi-Fi communications. The communications channel 890 of these embodiments is typically connected to an access point or router that provides access to outside networks including the Internet for allowing streaming applications and other over-the-top communications. Other embodiments provide streamed data to the system 800 using a set-top box that delivers the data over the HDMI connection of the input block 805. Still other embodiments provide streamed data to the system 800 using the RF connection of the input block 805. As indicated above, various embodiments provide data in a non-streaming manner. Additionally, various embodiments use wireless networks other than Wi-Fi, for example a cellular network or a Bluetooth network.

The system 800 may provide an output signal to various output devices, including a display 865, speakers 875, and other peripheral devices 885. The display 865 of various embodiments includes one or more of, for example, a touchscreen display, an organic light-emitting diode (OLED) display, a curved display, and/or a foldable display. The display 865 can be for a television, a tablet, a laptop, a cell phone (mobile phone), or other device. The display 865 can also be integrated with other components (for example, as in a smart phone), or separate (for example, an external monitor for a laptop). The other peripheral devices 885 include, in various examples of embodiments, one or more of a stand-alone digital video disc (or digital versatile disc) (DVR, for both terms), a disk player, a stereo system, and/or a lighting system. Various embodiments use one or more peripheral devices 885 that provide a function based on the output of the system 800. For example, a disk player performs the function of playing the output of the system 800.

In various embodiments, control signals are communicated between the system 800 and the display 865, speakers 875, or other peripheral devices 885 using signaling such as AV.Link, CEC, or other communications protocols that enable device-to-device control with or without user intervention. The output devices may be communicatively coupled to system 800 via dedicated connections through respective interfaces 860, 870, and 880. Alternatively, the output devices may be connected to system 800 using the communications channel 890 via the communications interface 850. The display 865 and speakers 875 may be integrated in a single unit with the other components of system 800 in an electronic device, for example, a television. In various embodiments, the display interface 860 includes a display driver, for example, a timing controller (T Con) chip.

The display 865 and speaker 875 may alternatively be separate from one or more of the other components, for example, if the RF portion of input 805 is part of a separate set-top box. In various embodiments in which the display 865 and speakers 875 are external components, the output signal may be provided via dedicated output connections, including, for example, HDMI ports, USB ports, or COMP outputs.

The embodiments can be carried out by computer software implemented by the processor 810 or by hardware, or by a combination of hardware and software. As a non-limiting example, the embodiments can be implemented by one or more integrated circuits. The memory 820 can be of any type appropriate to the technical environment and can be implemented using any appropriate data storage technology, such as optical memory devices, magnetic memory devices, semiconductor-based memory devices, fixed memory, and removable memory, as non-limiting examples. The processor 810 can be of any type appropriate to the technical environment, and can encompass one or more of microprocessors, general purpose computers, special purpose computers, and processors based on a multi-core architecture, as non-limiting examples.

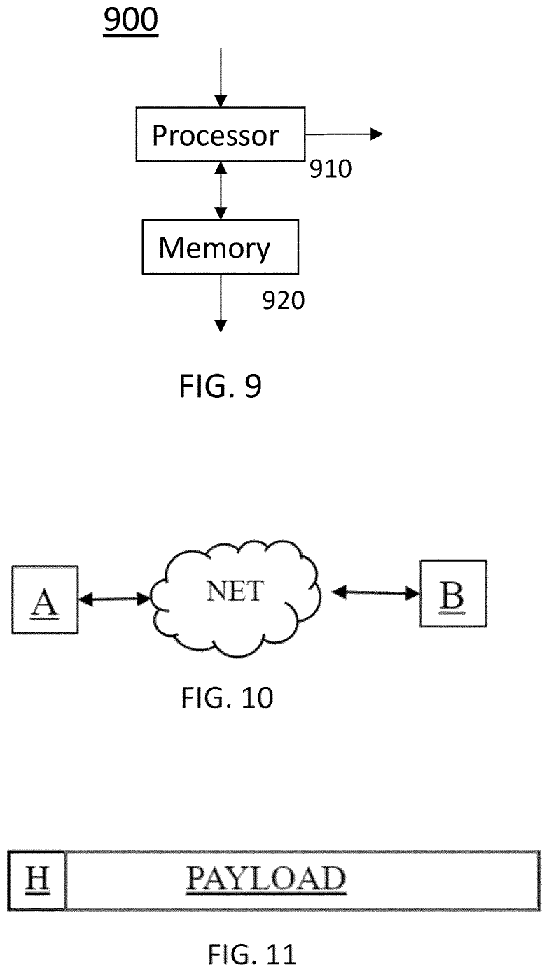

FIG. 9 illustrates a block diagram of a system within which aspects of the present embodiments may be implemented, according to another embodiment. FIG. 9 shows one embodiment of an apparatus 900 for encoding or decoding metadata used by an INR decoder according to any one of the embodiments described herein. The apparatus comprises

Processor 910 and can be interconnected to a memory 920 through at least one port. Both Processor 910 and memory 920 can also have one or more additional interconnections to external connections.

Processor 910 is also configured to encode at least one Implicit Neural Representation network representative of at least one part of a signal representative of a scene, and signal one or more syntax elements providing for using the encoded Implicit Neural Representation network to reconstruct the at least one part of a signal representative of a scene, using any one of the embodiments described herein.

In another variant, the processor 910 is configured to decode the one or more syntax elements providing for using the Implicit Neural Representation network representative of at least one part of a signal representative of a scene and reconstruct the at least one part of a signal representative of a scene using the one or more syntax elements and the Implicit Neural Representation network, using any one of the embodiments described herein. For instance, the processor 910 is configured using a computer program product comprising code instructions that implements any one of embodiments described herein.

In an embodiment, illustrated in FIG. 10, in a transmission context between two remote devices A and B over a communication network NET, the device A comprises a processor in relation with memory RAM and ROM which are configured to implement a method for encoding one or more syntax elements for using an INR decoder, as described with FIG. 1-7 and the device B comprises a processor in relation with memory RAM and ROM which are configured to implement a method for decoding one or more syntax elements for using an INR decoder as described in relation with FIG. 1-7. In accordance with an example, the network is a broadcast network, adapted to broadcast/transmit a coded INR and one or more syntax elements from device A to decoding devices including the device B. In some embodiments, the coded INR and the one or more syntax elements are transmitted in a same signal. In other embodiments, the coded INR and the one or more syntax elements are transmitted separately in distinct signals.

FIG. 11 shows an example of the syntax of a signal transmitted over a packet-based transmission protocol. Each transmitted packet P comprises a header H and a payload PAYLOAD. In some embodiments, the payload PAYLOAD may comprise one or more syntax elements for using an INR decoder, according to any one of the embodiments described above.

In some embodiments, the one or more syntax elements comprise at least one of an indication relating to the Implicit Neural Representation network, an information providing for constructing an input of the Implicit Neural Representation network, or an information relating to an output of the Implicit Neural Representation network.

In a variant, the indication relating to the Implicit Neural Representation network comprises at least one of a model type of the Implicit Neural Representation network, a type of computation of the Implicit Neural Representation network, a format of an encoding of the Implicit Neural Representation network, an indication of a tag URI identifying a format of the Implicit Neural Representation network, an indication of a URI identifying the Implicit Neural Representation network, an indicator indicating whether complexity information relating to the Implicit Neural Representation network is present or not, an indication of a type of parameters used by the Implicit Neural Representation network, an indication relating to a bit length of parameters used by the Implicit Neural Representation network, an indicator indicating a maximum number of parameters for the Implicit Neural Representation network, an indication of a maximum number of multiply-accumulate operations per inference of the Implicit Neural Representation network, or an indication of a size for storing uncompressed parameters of the Implicit Neural Representation network.

In another variant, the information providing for constructing an input of the Implicit Neural Representation network comprises at least one of an indication of a number of dimension of the input, an indication of a range of a dimension of the input, an indication of a quantizer of a dimension of the input, an indication of an offset of a zero value in the range, an indication of a number of transformation applied to the input, an indication of a type of transformation applied to the input, or an indication of one or more parameters of the transformation.

Various implementations involve decoding. “Decoding”, as used in this application, can encompass all or part of the processes performed, for example, on a received encoded INR in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application, for example, entropy decoding a sequence of binary symbols to reconstruct image, video or 3D data.

Note that the syntax elements as used herein, are descriptive terms. As such, they do not preclude the use of other syntax element names.

This disclosure has described various pieces of information, such as for example syntax, that can be transmitted or stored, for example. This information can be packaged or arranged in a variety of manners, including for example manners common in image, video or neural network standards such as putting the information into an SPS, a PPS, a NAL unit, a header (for example, a NAL unit header, or a slice header), or an SEI message. Other manners are also available, including for example manners common for system level or application level standards such as putting the information into one or more of the following:

a. SDP (session description protocol), a format for describing multimedia communication sessions for the purposes of session announcement and session invitation, for example as described in RFCs and used in conjunction with RTP (Real-time Transport Protocol) transmission.

b. DASH MPD (Media Presentation Description) Descriptors, for example as used in DASH and transmitted over HTTP, a Descriptor is associated to a Representation or collection of Representations to provide additional characteristic to the content Representation.

c. RTP header extensions, for example as used during RTP streaming.

d. ISO Base Media File Format, for example as used in OMAF and using boxes which are object-oriented building blocks defined by a unique type identifier and length also known as ‘atoms’ in some specifications.

e. HLS (HTTP live Streaming) manifest transmitted over HTTP. A manifest can be associated, for example, to a version or collection of versions of a content to provide characteristics of the version or collection of versions.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

A number of embodiments has been described above. Features of these embodiments can be provided alone or in any combination, across various claim categories and types.

1. A method, comprising:
encoding an implicit neural representation (INR) network representative of at least one part of a signal representative of a scene; and
signaling one or more syntax elements comprising at least one information providing for constructing an input of the INR network or an information relating to an output of the INR network.

2. An apparatus, comprising one or more processors, wherein the one or more processors is are operable to;
encode an implicit neural representation (INR) network representative of at least one part of a signal representative of a scene; and
signal one or more syntax elements comprising at least one information providing for constructing an input of the INR network or an information relating to an output of the INR network.

3. A method, comprising:
decoding an implicit neural representation (INR) network representative of at least one part of a signal representative of a scene;
decoding one or more syntax elements comprising at least one information providing for constructing an input of the INR network or an information relating to an output of the INR network; and
reconstructing the at least one part of the signal using the INR network and the one or more syntax elements.

4. (canceled)

5. An apparatus, comprising one or more processors, wherein the one or more processors are operable to:
decode an implicit neural representation (INR) network representative of at least one part of a signal representative of a scene;
decode one or more syntax elements comprising at least one information providing for constructing an input of the INR network or an information relating to an output of the INR network; and
reconstruct at least one part of the signal using the INR network and the one or more syntax elements.

6-7. (canceled)

8. The method of claim 1, wherein the one or more syntax elements comprise an indication relating to the INR network that comprises at least one of:
a model type of the INR network,
a type of computation of the INR network,
a format of an encoding of the INR network,
an indication of a tag URI identifying a format of the INR network,
an indication of a URI identifying the INR network,
an indicator indicating whether complexity information relating to the INR network is present or not,
an indication of a type of parameters used by the INR network,
an indication relating to a bit length of parameters used by the INR network,
an indicator indicating a maximum number of parameters for the INR network,
an indication of a maximum number of multiply-accumulate operations per inference of the INR network, or
an indication of a size for storing uncompressed parameters of the INR network.

9. The method of claim 3, wherein the at least one information providing for constructing an input of the INR network comprises at least one of:
an indication of a number of dimensions of the input,
an indication of a range of a dimension of the input,
an indication of a quantizer of a dimension of the input,
an indication of an offset of a zero value in the range,
an indication of a number of transformations applied to the input,
an indication of a type of transformation applied to the input, or
an indication of one or more parameters of the transformation.

10. The method of claim 3, wherein reconstructing the at least one part of the signal using the one or more syntax elements and the INR network comprises:
generating inputs from the one or more syntax elements, and
providing the generated inputs to the INR network.

11. The method of claim 3, wherein reconstructing the at least one part of the signal representative of a scene using the one or more syntax elements and the INR network further comprises:
performing an INR network inference using the one or more syntax elements.

12. (canceled)

13. The method of claim 11, wherein performing the INR network inference comprises configuring an inference engine using the one or more syntax elements.

14. The method of claim 3, wherein reconstructing the at least one part of the signal using the one or more syntax elements and the INR network further comprises:
combining an output of the INR network and inputs of the INR network using the one or more syntax elements.

15. The method of claim 14, wherein combining an output of the INR network and inputs of the INR network using the one or more syntax elements comprises arranging the output of the INR network in a given format or in a given range of values.

16-17. (canceled)

18. A non-transitory computer readable medium storing executable program instructions to cause a computer executing the program instructions to perform a method according to claim 3.

19-24. (canceled)

25. A device comprising:
an apparatus according to claim 5; and
at least one of (i) an antenna configured to receive or transmit a signal, the signal including a bitstream comprising data encoding at least one part of an implicit neural representation (INR) network representative of at least one part of a signal representative of a scene or data for updating the at least one INR network; and data representative of one or more syntax elements comprising at least one information providing for constructing an input of the INR network or an information relating to an output of the INR network, (ii) a band limiter configured to limit the signal to a band of frequencies that includes the bitstream, or (iii) a display configured to display the at least one part of the signal representative of the scene.

26. (canceled)

27. The apparatus of claim 2, wherein the one or more syntax elements comprises an indication relating to the INR network that comprises at least one of:
a model type of the INR network,
a type of computation of the INR network,
a format of an encoding of the INR network,
an indication of a tag URI identifying a format of the INR network,
an indication of a URI identifying the INR network,
an indicator indicating whether complexity information relating to the INR network is present or not,
an indication of a type of parameters used by the INR network,
an indication relating to a bit length of parameters used by the INR network,
an indicator indicating a maximum number of parameters for the INR network,
an indication of a maximum number of multiply-accumulate operations per inference of the INR network, or
an indication of a size for storing uncompressed parameters of the INR network.

28. The apparatus of claim 5, wherein the at least one information providing for constructing an input of the INR network comprises at least one of:
an indication of a number of dimensions of the input,
an indication of a range of a dimension of the input,
an indication of a quantizer of a dimension of the input,
an indication of an offset of a zero value in the range,
an indication of a number of transformations applied to the input,
an indication of a type of transformation applied to the input, or
an indication of one or more parameters of the transformation.

29. The apparatus of claim 5, wherein reconstructing the at least one part of the signal using the one or more syntax elements and the INR network comprises:
generating inputs from the one or more syntax elements,
providing the generated inputs to the INR network.

30. The apparatus of claim 5, wherein reconstructing the at least one part of the signal using the one or more syntax elements and the INR network further comprises:
performing an INR network inference using the one or more syntax elements.

31. The apparatus of claim 30, wherein performing the INR network inference comprises configuring an inference engine using the one or more syntax elements.

32. The apparatus of claim 5, wherein reconstructing the at least one part of the signal using the one or more syntax elements and the INR network further comprises:
combining an output of the INR network and inputs of the INR network using the one or more syntax elements.

33. The apparatus of claim 32, wherein combining an output of the INR network and inputs of the INR network using the one or more syntax elements comprises arranging the output of the INR network in a given format or in a given range of values.
